(19) United States
(12) Patent Application Publication
(10) Pub. No.: US 2015/0278956 A1
(43) Pub. Date: Oct. 1, 2015

(54) Commission Processing System and Method for Non-Traded Real Estate Investment Trusts and Non-Traded Business Development Companies

(71) Applicant: ANDREW DORNBUSCH, Minneapolis, MN (US)

(72) Inventor: ANDREW DORNBUSCH, Minneapolis, MN (US)

(21) Appl. No.: 14/669,949

(22) Filed: Mar. 26, 2015

Related U.S. Application Data
(60) Provisional application No. 61/971,344, filed on Mar. 27, 2014.

(51) Int. Cl. G06Q 40/06

(52) U.S. Cl. CPC G06Q 40/06; G06Q 50/16

(57) ABSTRACT

Methods and systems for managing investments in a non-traded real estate investment trust or non-traded business development company are disclosed. One method includes receiving an identification of funds and investment instructions at a computing system from an investor, and automatically calculating commissions and fees based on the identification of funds and the investment instructions. The method also includes issuing shares to the investor based on a full value of the identified funds, investing the full value of the identified funds in an investment including in real estate or other assets, and automatically calculating a recurring fee for the investment.

### CROSS REFERENCE TO RELATED APPLICATION

The present application claims priority from U.S. Provisional Patent Application No. 61/971,344, filed on Mar. 27, 2014, the disclosure of which is hereby incorporated by reference in its entirety.

### BACKGROUND

Over the past twenty years, various real estate investment firms (“Sponsors”) have created and marketed non-traded real estate investment trusts (“REITs”) and non-traded business development companies (“BDCs”). In contrast to publicly traded investments, shares of non-traded REITs and BDCs are illiquid and arbitrarily valued at a fixed price, generally $10.00-$25.00 per share. Because there is no formal market for non-traded REITs or BDCs, Sponsors rely on financial advisors to sell shares directly to their clientele. In order to incentivize these sales, Sponsors pay commissions of up 10% of gross proceeds to financial advisors and their broker-dealers. Additionally, Sponsors assess other upfront, non-commission fees and expenses generally equaling 1.5%-5%. Currently, such fees are not required to be disclosed to customers on customer account statements based on NASD Rules 2310 and 2340.

For example, a client's investment in non-traded REIT or BDC shares is processed as follows. First, a client submits paperwork and funds to financial advisor or directly to Sponsor or its transfer agent. Then, the Sponsor or its transfer agent, through an automated system, subtracts commissions and fees from the funds and routes them to the participating financial advisor or broker-dealer. The Sponsor or its transfer agent then issues shares to the investor based on the full value of the funds submitted without regard for the commissions or fees subtracted (i.e., a client investing $100,000 will receive a statement reflecting 10,000 shares at $10 per share even though $11,500-$15,000 of invested proceeds have been paid as fees). The Sponsor then invests net proceeds of sale into real estate or other assets ($85,000-$88,500).

The above separation and apportionment of fees and payments has disadvantages to investors. For example, because these costs are paid out of initial proceeds, they effectively reduce the amount of capital available for investment in real estate or other assets by 11.5%-15%, thereby dramatically reducing overall returns to investors. Further, the substantial reduction in initial capital resulting from fees and expenses is unappealing to many investors and, once disclosed, decreases the desirability of non-traded REITs and BDCs.

Additionally, most REITs and BDCs pay regular income to their investors in the form or monthly or quarterly distributions. Generally, REITs and BDCs offer investors the opportunity to reinvest their distribution income through a Distribution Reinvestment Plan (“DRP”). Investors electing to use the DRP receive additional shares in the REIT or BDC in lieu of cash distributions. In order to incent investors to use DRPs, Sponsors historically offer DRP shares at a 5% discount to the initial offering price. Two rationales for this discount exist. First, no commissions or fees are paid on capital invested pursuant to the DRP. Therefore, even after applying the discount, Sponsors receive more investable capital through the sale of DRP shares than primary offering shares. Second, laws and regulations surrounding REITs and BDCs prohibit Sponsors from applying a discount of more than 5% of fair market value (“FMV”) to shares sold pursuant to any offering.

The above method of calculating DRP shares is flawed and potentially creates significant inefficiencies which could substantially reduce DRP usage. If Sponsors begin to report per share values on investor statements net of upfront commissions and fees, DRP shares will be offered at a price higher than reflected on investor statements.

For example, assuming a $10.00 share price and commissions and fees of 10%, net statement value would equal $9.00. As mentioned, Sponsors are prohibited from discounting DRP shares more than 5% of FMV. Because the Internal Revenue Service historically deems offering price, not net value, representative of FMV, the Sponsors in this example could offer DRP shares at a price no less than $9.50. This disparity between DRP price and stated value creates a disincentive for investors to reinvest distribution income. Because DRP usage tends to increase the overall performance of REITs and BDCs, the outcome described above is undesirable to Sponsors and investors.

A potential solution to the DRP price disparity involves Sponsors creating a different class of shares to offer pursuant to their DRPs. Any such class would carry stated value less than shares sold in the primary offering, thereby allowing a discounted price less than or equal to the stated, net value of primary offering shares. However, the entities responsible for processing and holding REIT and BDC shares (transfer agents and custodians) create accounts and assess fees based on the number of different shares classes held. Therefore, the solution described above would require each client to open and maintain two accounts and would double the administrative fees associated with holding shares in any one REIT or BDC.

Adjusting the apportionment of funds to investment and fees associated with Sponsors also adds technical complexity to existing software tailored to assisting with management of investments in non-traded REIT or BDC shares. In particular, DRP shares that are typically of a different class than the original investment shares in the non-traded REIT or BDC are held in a new account for the same investor. This results in technical and operational complexities regarding maintaining and linking two accounts associated with the same investor, and further doubles the administrative costs to that investor.

Accordingly, improvements in the above arrangement are desirable so that substantially more investor capital is used for investment which, in turn, would allow for higher net value REIT and BDC statement prices.

### SUMMARY

In accordance with the following disclosure, the above and other issues are addressed by the following:

In a first aspect, a computerized method for managing investments in a non-traded real estate investment trust and non-traded business development companies includes receiving an identification of funds and investment instructions at a computing system from an investor, and automatically calculating commissions and fees based on the identification of funds and the investment instructions. The method further includes issuing shares to the investor based on a full value of the identified funds, investing the full value of the identified funds in an investment including sale proceeds of real estate, and automatically calculating a recurring fee for the investment.

In a second aspect, a system comprising a non-traded REIT or BDC investment management application (“Non-Traded Investment Management Application”) stored in memory and executing on a computing system is disclosed. When executed, the Non-Traded Investment Management Application causes the computing system to receive an identification of funds and investment instructions at a computing system from an investor, automatically calculate commissions and fees based on the identification of funds and the investment instructions, wherein the commissions, issue shares to the investor based on a full value of the identified funds, invest the full value of the identified funds in an investment including sale proceeds of real estate, and automatically calculate a recurring fee for the investment.

### BRIEF DESCRIPTION OF THE DRAWINGS

FIG. 1 illustrates an example data arrangement useable in connection with a Non-Traded Investment Management Application, in an example application of the of the present disclosure;

FIG. 2A is a schematic block diagram of a computing system used to implement a Non-Traded Investment Management Application, according to an example embodiment;

FIG. 2B is an example schematic view of a database including consolidated initial and reinvestment account records, according to an example embodiment;

FIG. 3 is a flowchart of an example process for apportioning fees according to an investment in a non-traded real estate investment trust or non-traded business development company that can be performed by Non-Traded Investment Management Application of FIG. 2;

FIG. 4 is a flowchart of a second example process for apportioning fees according to an investment in a non-traded real estate investment trust or non-traded business development company that can be performed by the Non-Traded Investment Management Application of FIG. 2;

FIG. 5 is a table illustrating a comparison between the amortizing scenario performed according to example embodiments and traditional investment allocations;

FIG. 6 is a table illustrating a comparison between investment performance in both primary and DRP investments using the systems and methods discussed herein;

FIG. 7 illustrates a process flow in which initial and DRP investments are maintained in separate accounts; and

FIG. 8 illustrates a process flow in which initial and DRP investments are maintained in a consolidated account.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

As briefly described above, embodiments of the present invention are directed to a non-traded real estate investment trust (REIT) or non-traded business development company (“BDC”) investment management system (“Non-Traded Investment Management Application”) in which a method of apportioning commission and fee payments is provided having advantageous effects both with respect to administration and with respect to returns available to entities involved in such investments.

In some embodiments, in order to improve client returns and investment transparency, Sponsors adopt an alternative commission and fee payment structure. By paying commissions and fees with Sponsor or third party funds, all investor capital would consequently initially be used for investment in real estate, thus improving performance. In such embodiments, Sponsors compensate themselves for this additional capital outlay by adding a recurring fee to the investment structure, paid on total assets under management within the REIT. Essentially, this process would have the effect of annuitizing the commissions and fees paid from the initial capital raise. The initial capital outlay required by this strategy could be reduced by altering the commission structure itself, so that a portion is paid at the time of sale with a trail commission paid out of operating income over the course of months or years. Still further, using the systems described herein, Sponsors can manage DRP shares from reinvestment in the same account as original investments, thereby reducing operational complexity of the overall system, reducing the number of accounts and records associated with a single investor and improving computational efficiency of administering the account of that investor (and for the associated Sponsor).

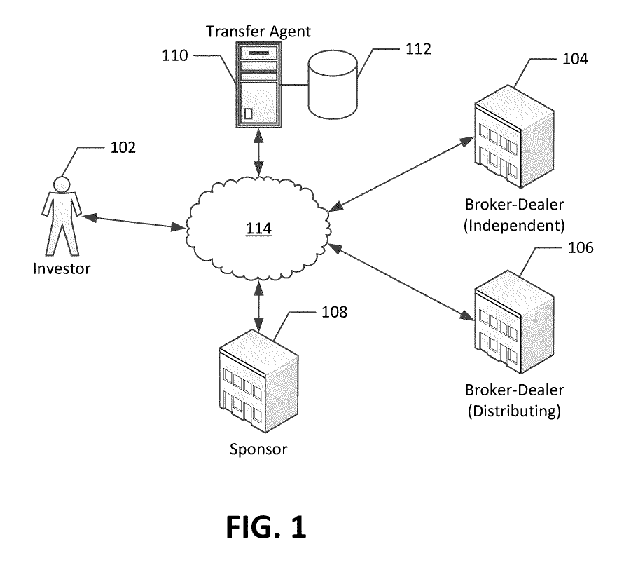

Referring now to FIG. 1, an example arrangement 100 in which the above aspects of the present disclosure can be implemented is depicted. Generally, the arrangement 100 includes an investor 102 who can communicate with one or more broker-dealers 104, 106, to invest in a non-traded real estate investment trust. In the context of the present disclosure, one or more such broker-dealers (e.g. broker-dealer 104) can be an independent broker-dealer which offers shares in a Sponsor's REIT or BDC to its investors. Additionally, one or more such broker-dealers (e.g., broker-dealer 106) can be a distributing broker-dealer owned, affiliated, or working on behalf of Sponsor to engage third party independent broker dealers to offer shares in Sponsor's REIT or BDC to their investors. Generally, a Sponsor 108 corresponds to a real estate investment company that structures the REIT or BDC and offers it for sale.

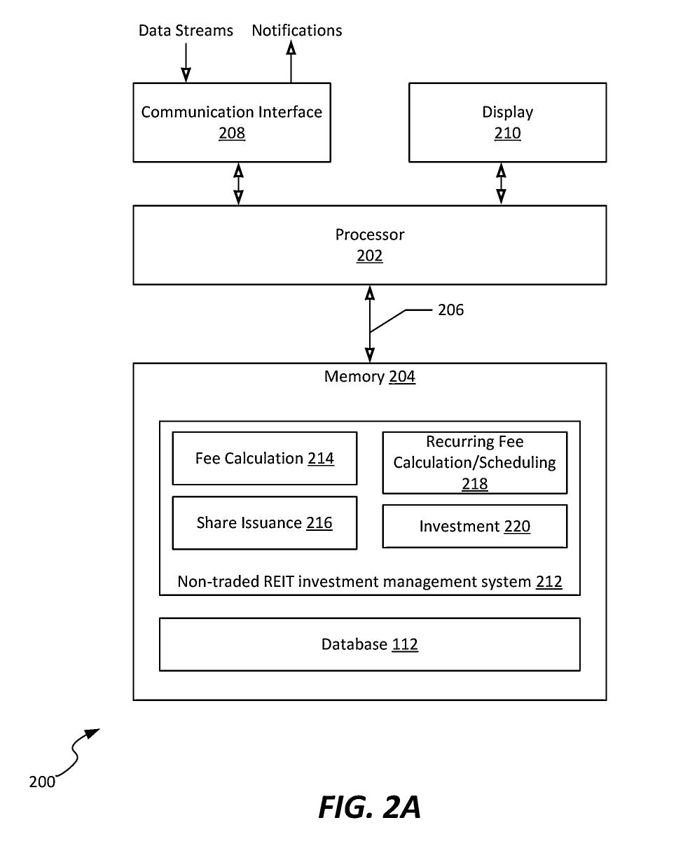

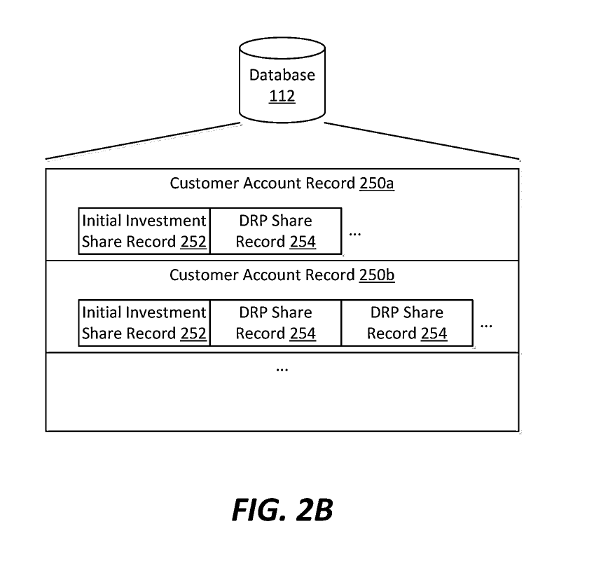

In the embodiment shown, a transfer agent 110 communicates among the investor 102, the broker-dealers 104, 106, and the Sponsor 108, via a network 114. The transfer agent 110 accepts paperwork (electronic or non-electronic) and funds from investor, financial advisor, or broker dealer for processing. The transfer agent 110 is associated with a database 112 storing financial transaction records, and acts as a computing system useable to manage and calculate upfront and/or recurring fees/payments that are incurred according to the following disclosure. The transfer agent 110 can also manage distribution of funds automatically via wire transfers or other electronic funds transfers. In some embodiments, the transfer agent 110 includes a computing system such as the one discussed below in connection with FIG. 2A, which includes a Non-Traded Investment Management Application.

In various embodiments, the network 114 can be any of a variety of types of wired or wireless networks, or some combination thereof In some examples, the network 114 comprises the Internet.

Referring now to FIG. 2A, a schematic block diagram of a computing system 200 is shown. The computing system 200 can be, in some embodiments, used to implement a complex event processing system. In general, the computing system 200 includes a processor 202 communicatively connected to a memory 204 via a data bus 206. The processor 202 can be any of a variety of types of programmable circuits capable of executing computer-readable instructions to perform various tasks, such as mathematical and communication tasks.

The memory 204 can include any of a variety of memory devices, such as using various types of computer-readable or computer storage media. A computer storage medium or computer-readable medium may be any medium that can contain or store the program for use by or in connection with the instruction execution system, apparatus, or device.

In the embodiment shown the memory 204 stores a Non-Traded Investment Management Application 212, as well as a database 112. Non-Traded Investment Management Application 212 includes a fee calculation component 214, a share issuance component 216, a recurring fee calculation component 218, and an investment component 220. The fee calculation component 214 is configured to, upon receipt of funds and investment identification information (e.g., into a web form or as received on paper and subsequently entered), calculate a fee portion of the funds to be invested. This can be received by the Sponsor or agent, who then uses the transfer agent to calculate commissions and fees. These commissions and fees to third parties (e.g., broker-dealers), would then be paid by the Sponsor from funds of the Sponsor or some third party. The share issuance component 216 determines a number and type of shares to issue, and issues shares to the investor based on the desired investment.

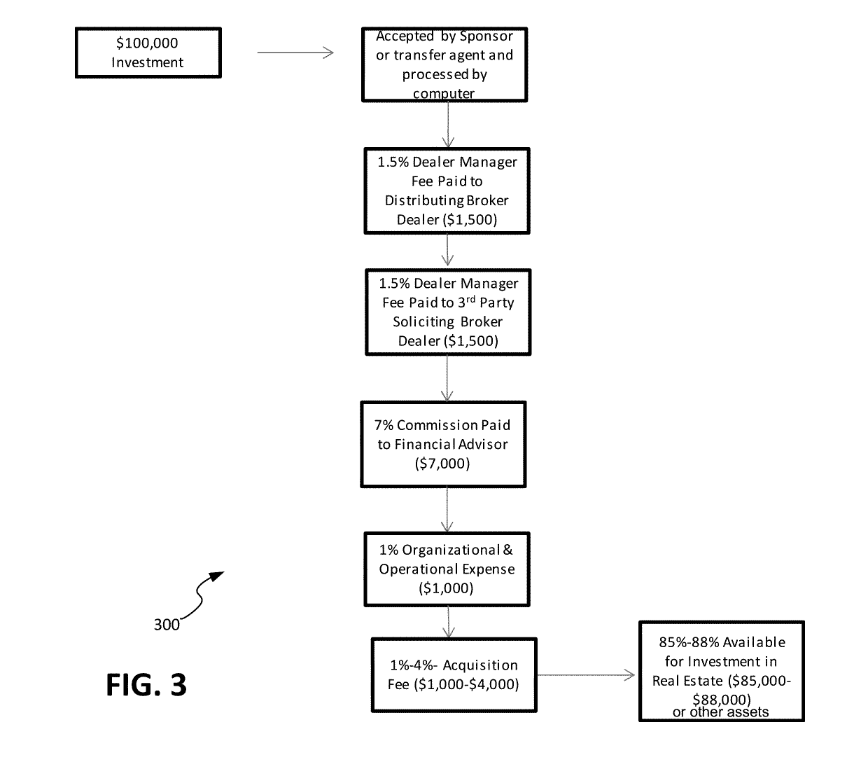

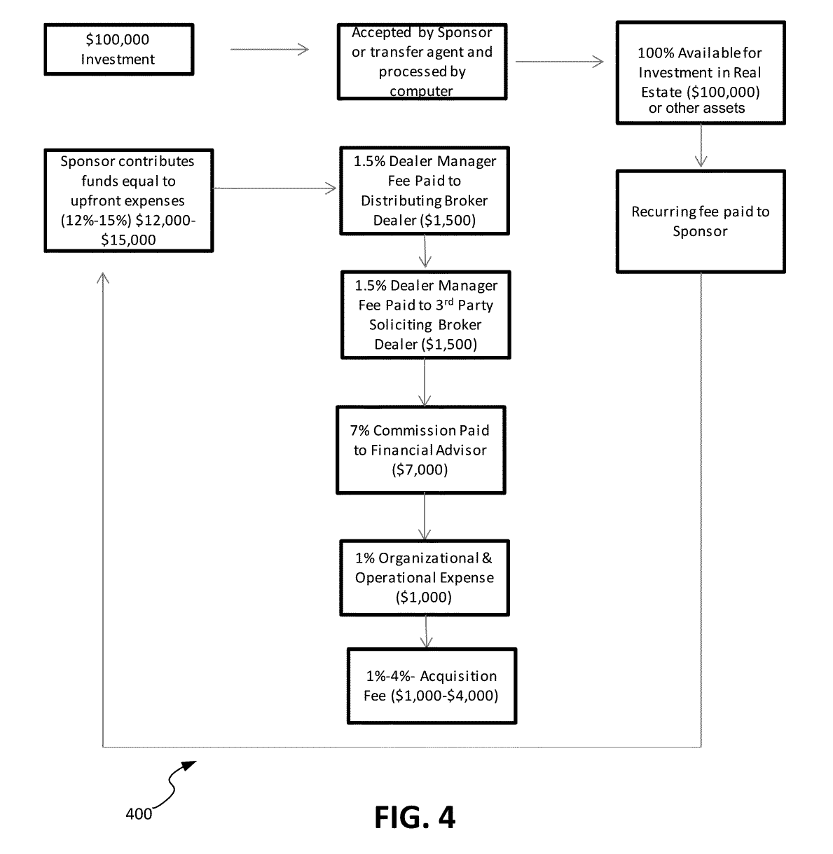

The recurring fee calculation component 218 determines, based on the fee calculated, a recurring fee to be collected from proceeds of an investment, to offset the commissions and fees that are paid by the Sponsor as noted above. Example operation of the recurring fee calculation component 218 is discussed below in connection with FIGS. 3-4.

The investment component 220 manages investments in real estate offered by Sponsor 108, and the database 112 stores details regarding the investments and funds received on behalf of the investor 112 as well as the broker-dealers 104, 106, and/or the Sponsor 108.

In the embodiment shown, the computing system 200 can also include a communication interface 208 configured to receive data and/or indications of funds transfers or investment instructions from an investor or broker-dealer, or otherwise communicate regarding fees, scheduled funds transfers, or other communications as may be generated by the Non-Traded Investment Management Application 212, as well as a display 210 for presenting various investment information or fee scheduling issues.

An investment in a non-traded REIT or BDC as would be administered by the Non-Traded Investment Management Application 212 would proceed as follows. First, an investor submits paperwork and funds to financial advisor or directly to Sponsor or its agent. The Sponsor or its agent, through an automated system, calculates commissions and fees, which it pays with its own funds or those of a third party. The Sponsor or its agent issues shares to the investor based on the full value of the funds submitted, and the Sponsor invests 100% of sale proceeds into real estate or other assets.

Sponsor, through an automated, computerized system, calculates and subtracts a recurring fee from the operating income of the portfolio as compensation for its initial capital outlay. Generally, the upfront commissions and fees associated with non-traded REITs or BDCs will include:
A broker-dealer commission, which is paid to the broker-dealers distributing and soliciting investments in the traded REIT or BDC. The commission is typically 3%;
A selling commission, which is paid to financial advisor selling the non-traded REIT or BDC; typically 7%;
An organization and operational expense, which is paid out of initial invested capital; typically 1%; and
Acquisition fees, which are paid out of initial invested capital; typically 1%-4%.

As seen in FIG. 2B, the database 112 of FIG. 2A can store a plurality of investment account records 250, each associated with a different investor (example separate investment account records shown as records 250a-b, respectively). Each investment account record 250 can include an initial investment share record 252, which can store information associated with the investor as well as the initial investment details (e.g., cost, timing, proceeds, etc.). Each investment account record 250 can also optionally include one or more DRP share records 254, representing reinvestment of proceeds into a share at a different share class than the initial investment. Accordingly, rather than maintaining different account records and links between those records to maintain all records for a particular customer, operation of the system overall is simplified by managing both initial investment share records 252 and DRM share records 254 within the same customer account, and therefore within the same customer account record 250. Such simplification provides substantial operational efficiencies relating to avoidance of duplication of customer data across accounts, maintenance of links across multiple reinvestment accounts, and other complexities.

Referring now to FIGS. 3-6, example processes by which such investment systems can operate are disclosed. In FIG. 3, an example process 300 is illustrated showing an example investment of $100,000. In this example, the investment is accepted by a sponsor or transfer agent, and processed by a computer. A dealer manager fee (typically about 1.5%) is paid to a distributing broker-dealer. Additionally, a dealer manage fee is paid to a third party soliciting broker-dealer (again, typically about 1.5%). Further, a commission (typically about 7%) is paid to a financial advisor, and an organizational and operational fee (typically about 1%) is paid. Finally, a 1-4% acquisition fee is typically paid, leaving only about 85-88% of the original assets available for investment in real estate or other assets. This represents a traditional investment process.

By way of contrast, in FIG. 4, a process 400 includes receiving the investment by a Sponsor or transfer agent, which is then processed by a computer. The full amount of that investment is used to purchase real estate investments. A recurring fee is paid to the Sponsor by the investor. In return, the Sponsor agrees to contribute funds equal to the upfront expenses of about 12-15% (as discussed in connection with FIG. 3). As such, although the investor now pays a recurring fee to the Sponsor, the investor has full use of funds for his/her investment.

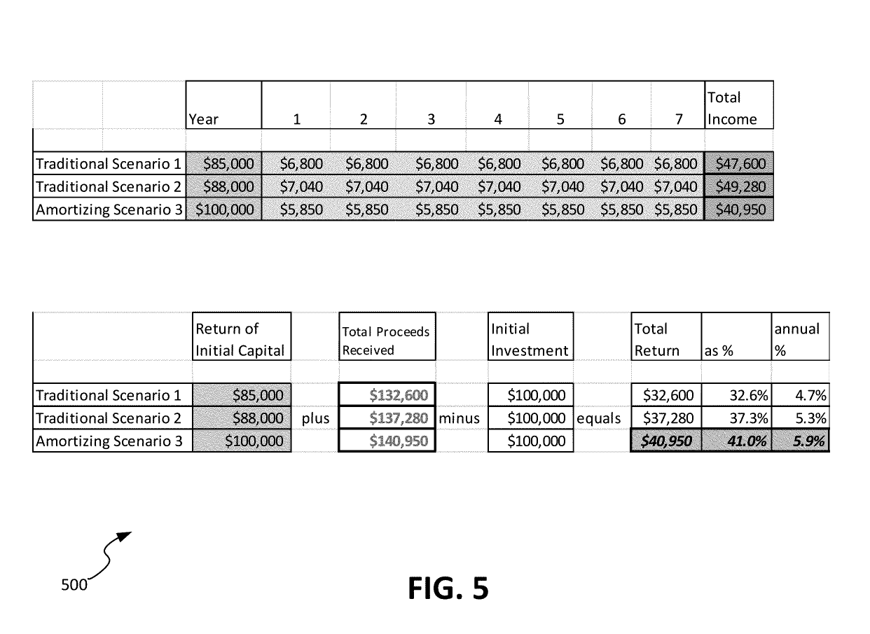

Referring to FIG. 5, an example return on a $100,000 investment is illustrated, comparing traditional investments in non-traded REITs or non-traded BDCs to the amortized fee arrangement performed by the methods and computerized systems of the present disclosure. Generally, the example shown assumes an 8% return on real estate or other assets and a recurring fee (applicable only in the amortizing scenario) of 2.15%. As can be seen in the example shown, although total income is higher over the life of the investment in a traditional scenario, the total return on investment is higher in the amortizing scenario because of the lower initial capital investment to account for fees in the traditional scenarios. As such, the total return, and the return as a percentage of the original investment, is higher in the amortizing scenario. Accordingly, not only is this scenario more appealing to investors (who do not lose fees upfront as part of investment capital) it results in a higher overall return to investors over a typical 7 year lifespan of such an investment.

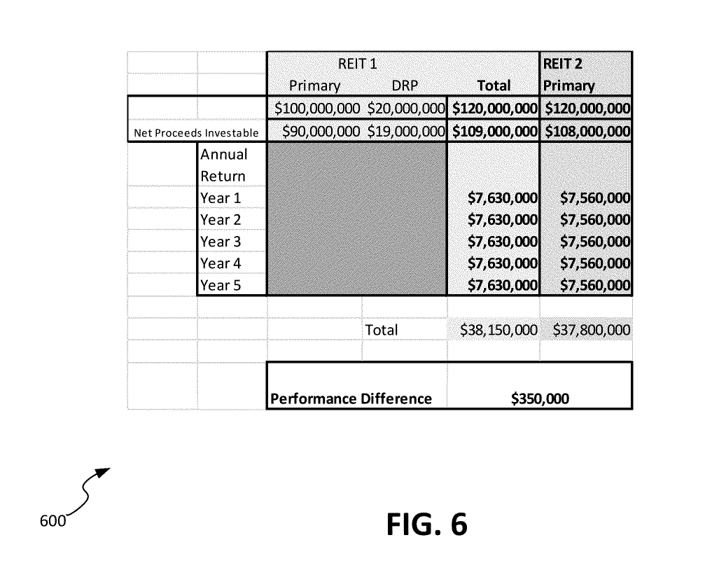

Referring to FIG. 6, a further example return on investment is illustrated in the context of a possible reinvestment scenario. In this case, two hypothetical investments of $120 million in funds are compared. The first investment is comprised of $100 million in primary shares and $20 million in DRP shares. The second investment consists entirely of primary shares. As this comparison demonstrates the use of DRP shares increase the overall rate of return for an investor.

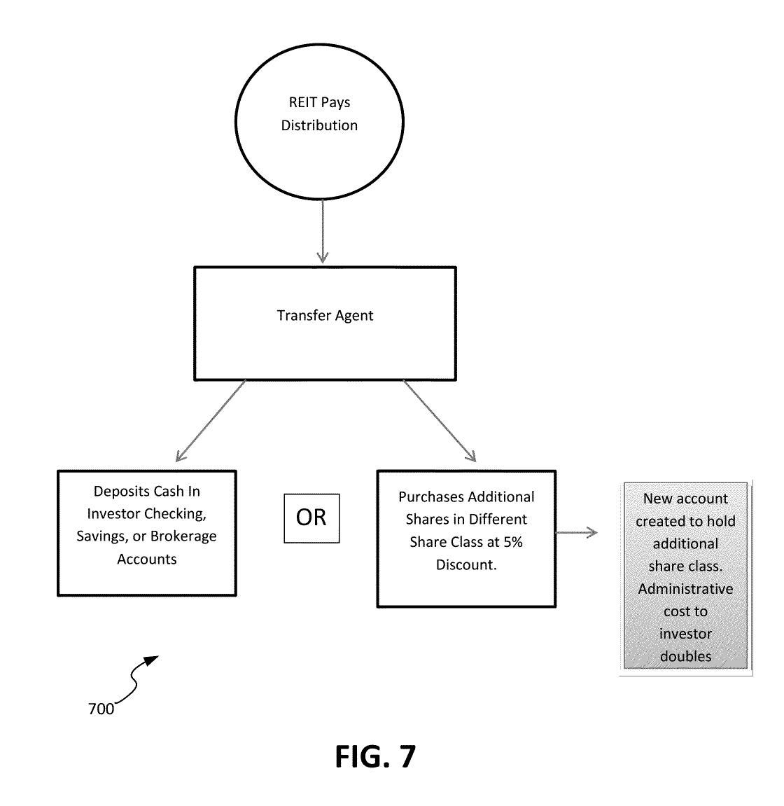

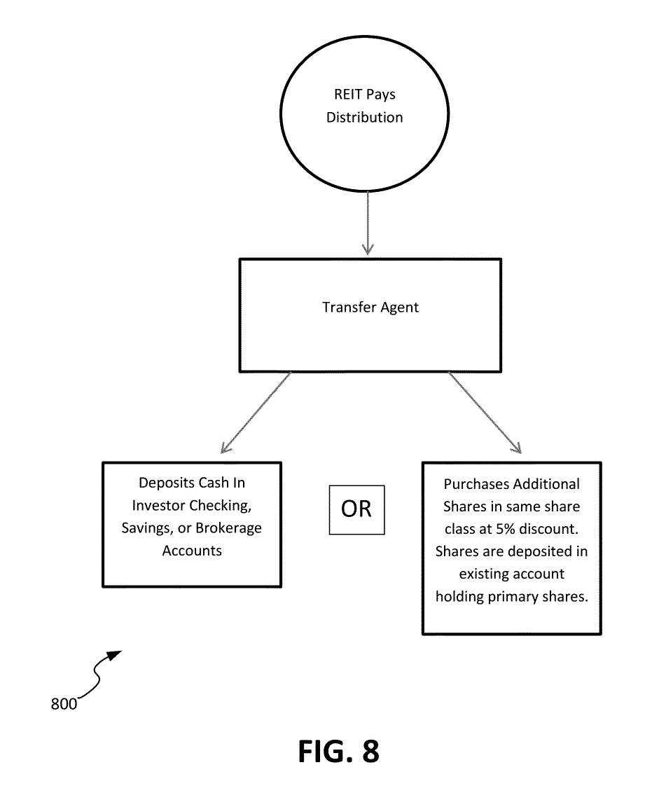

Referring to FIGS. 7-8, an example comparison of systems for managing reinvestment of proceeds from non-traded REITs or non-traded BDCs is provided. As illustrated in one possible arrangement as shown in FIG. 7, a process flow 700 may occur in which a REIT or BDC pays a distribution to a Transfer Agent, which in turn would deposit proceeds in an investor account or allow that investor to purchase additional shares in a different share class at a discount, typically 5%. However, as noted in FIG. 7, such investments are managed in a different account because the transfer agent cannot practically combine share classes in a single account to accommodate each share class. By way of comparison, in process flow 800 of FIG. 8, sponsors offer shares at a discount to the offering price; this appearance of a discounted price does not require use of a secondary account because the issued shares can be of the same share class. This avoids creation of a further account record and associated computational and administrative tasks of maintaining a link between an initial account and a reinvestment account. Rather, all such investments can be maintained within the same set of account records, for example within the database 112 of FIGS. 2A-2B.

Embodiments of the present disclosure can be implemented as a computer process (method), a computing system, or as an article of manufacture, such as a computer program product or computer readable media or computer recordable media. The computer program product may be a computer storage media readable by a computer system and encoding a computer program of instructions for executing a computer process. Accordingly, embodiments of the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system.

Although particular features are discussed herein as included within a computer (e.g., computing device 200), it is recognized that in certain embodiments not all such components or features may be included within a computer executing according to the methods and systems of the present disclosure. Furthermore, different types of hardware and/or software systems could be incorporated into such an electronic computing device.

In accordance with the present disclosure, the term computer readable media may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally includes at least some tangible component on which computer-executable instructions can be stored, and can be included in a computer storage device such as any of the devices discussed above. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media. Further, the disclosed methods' stages may be modified in any manner, including by reordering stages and/or inserting or deleting stages, without departing from the overall concept of the present disclosure.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A computerized method for managing investments in a non-traded real estate investment trust or business development company, the method comprising:
receiving an identification of funds and investment instructions at a computing system from an investor;
automatically calculating commissions and fees based on the identification of funds and the investment instructions;
issuing shares to the investor based on a full value of the identified funds;
investing the full value of the identified funds in an investment in real estate or other assets; and
automatically calculating a recurring fee for the investment.

2. The computerized method of claim 1, further comprising automatically subtracting the recurring fee from the operating income of the investment.

3. The computerized method of claim 1, wherein automatically calculating commissions and fees is performed by a Non-Traded Investment Management Application executing on a computing system.

4. The computerized method of claim 1, wherein the investment comprises an ownership share in a non-traded real estate investment trust or non-traded business development company.

5. The computerized method of claim 1, further comprising storing information regarding the investment in a customer account record of a database associated with the computing system.

6. The computerized method of claim 5, further comprising:
receiving an indication to reinvest proceeds in a subsequent investment in real estate or other assets;
reinvesting proceeds in the subsequent investment; and
storing information regarding the subsequent investment in the customer account record.

7. The computerized method of claim 6, wherein the subsequent investment is an investment in the same real estate or other asset as the investment.

8. The computerized method of claim 6, wherein the investment is in a share class and the subsequent investment is in the same share class.

9. The computerized method of claim 6, wherein the subsequent investment is made at a discounted share price.

10. A system comprising a Non-Traded Investment Management Application stored in memory and executing on a computing system, wherein, when executed, the Non-Traded Investment Management Application causes the computing system to:
receive an identification of funds and investment instructions at a computing system from an investor;
automatically calculate commissions and fees based on the identification of funds and the investment instructions, wherein the commissions;
issue shares to the investor based on a full value of the identified funds;
invest the full value of the identified funds in an investment in real estate or other assets; and
automatically calculate a recurring fee for the investment.

11. The system of claim 10, wherein the Non-Traded Investment Management Application causes the computing system to, when executed, automatically subtract the recurring fee from the operating income of the investment.

12. The system of claim 10, wherein information regarding the investment is stored in a database managed by the computing system.

13. The system of claim 12, wherein information regarding the investment is stored in a customer account record within the database.

14. The system of claim 13, wherein, upon receiving an indication to reinvest proceeds in a subsequent investment in real estate or other assets, the computing system is further configured to:
reinvest proceeds in the subsequent investment; and
store information regarding the subsequent investment in the customer account record alongside the information regarding the investment.

15. The system of claim 14, wherein the subsequent investment is an investment in the same real estate or other asset as the investment.

16. The system of claim 14, wherein the investment is in a share class and the subsequent investment is in the same share class.

17. The system of claim 14, wherein the subsequent investment is made at a discounted share price.
